(19) United States
(12) Patent Application Publication
(10) Pub. No.: US 2003/0189478 A1
(43) Pub. Date: Oct. 9, 2003

(54) Detection device

(76) Inventors: Chih-Hsiung Shen, Hsin Chu (TW); Chun-Fang Hsiao, Hsin Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/118,372

(22) Filed: Apr. 9, 2002

(51) Int. Cl. H01F 27/28

(52) U.S. Cl. 336/231; 250/231.16

(57) ABSTRACT

The present invention provides a detection device, which comprises a light-emitting device for projecting a light source to a slotted mask. An optical detector is used to detect the light passing through the slots. A plurality of optical detection units are disposed in the optical detector. Each of the optical detection unit comprises an optical detection component for converting light into a current signal. The optical detection component is connected to a signal selection circuit via a current mirror circuit. When the current of one of optical detection units is maximal in all of the optical detection units and larger than a half of the total current, the optical detection unit will output a voltage signal of high voltage. Otherwise, it will output a voltage signal of low voltage. The present invention has the advantages of high resolution and high noise immunity.

### FIELD OF THE INVENTION

The present invention relates to an optical device and, more particularly, to a detection device for detecting variations of position or angle.

### BACKGROUND OF THE INVENTION

Along with enhancement of scientific technology and quality of life, electronic information products go deep into every aspect of human lives. For general electronic products, operations of internal circuits therein are controlled by outside force or influence. With the structure of a mouse connected to a common computer as an example, the roll of a track ball is exploited to drive a position-detecting device to act, thereby controlling the motion of a cursor on a computer according to the detected signal. In a position-detecting device, a light source projects light to a rotary wheel driven by the track ball, and a plurality of gaps are disposed on the rotary wheel. The detection device is used to detect variation of position of the incident light passing through the gaps, and convert it into an electronic signal for output. In order to effectively discriminate the variation of light source so as to control the cursor's motion, two optical detectors and a current comparator are disposed in a detection device, whereby the optical detectors transform the light into currents, and a comparison result is outputted to a computer in electronic signals after the currents are compared by the current comparator.

In the above design, because only two sets of currents are compared, the resolution of detection is inferior. Moreover, when the light source projects light between the two detection devices, they cannot discriminate the light source's position, resulting in inexact determination of variations of position.

Additionally, in common acoustics, a rotary switch is turned to control the volume of sound. This is accomplished by turning the rotary switch to adjust the variation of varistors disposed on internal control circuits in the acoustics, thereby adjusting the volume of sound. However, this kind of analog adjustment has a lower accuracy, and easily causes noise, hence not conforming to the present trend of digital technology.

Accordingly, the present invention aims to propose a detection device for detecting variations of position or angle, which can apply to a mouse or a rotary switch.

### SUMMARY OF THE INVENTION

The primary object of the present invention is to propose a detection device for detecting variations of position or angle. The detection device can apply to various kinds of electronic products, whose operations are controlled via electronic signals generated by variations of position. Moreover, the detection device has the advantages of high resolution and easily readable signal.

Another object of the present invention is to propose a detection device having noise-resistant function.

According to the present invention, a detection device comprises a light-emitting device, which projects light to a slotted mask. An optical detector is used to detect the light passing through the slots. The optical detector comprises four optical detection units. An optical detection component for converting light into a current signal is disposed in each of the optical detection units. The optical detection component is connected to a signal selection circuit via a current mirror circuit. When the current of one of the optical detection units is maximal in all the optical detection units and is larger than a half of the sum of all the currents, the optical detection unit outputs a high voltage signal of value 1. Otherwise, it outputs a low voltage signal of value 0.

The various objects and advantages of the present invention will be more readily understood from the following detailed description when read in conjunction with the appended drawings, in which:

### BRIEF DESCRIPTION OF THE DRAWINGS

FIG. 1 is a structure diagram of a detection device of the present invention;

FIG. 2 is a structure block diagram of an optical detector of the present invention; and

FIG. 3 is a structure block diagram of each optical detection unit of the present invention.

### DETAILED DESCRIPTION OF THE PREFERRED EMBODIMENTS

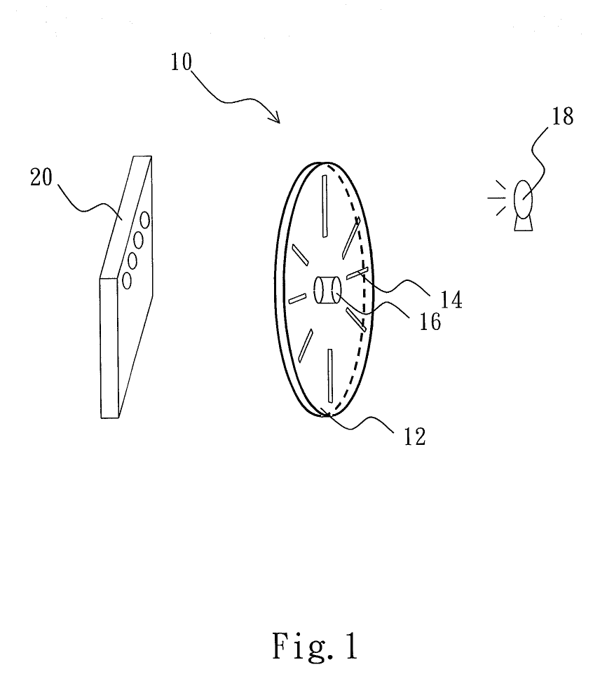

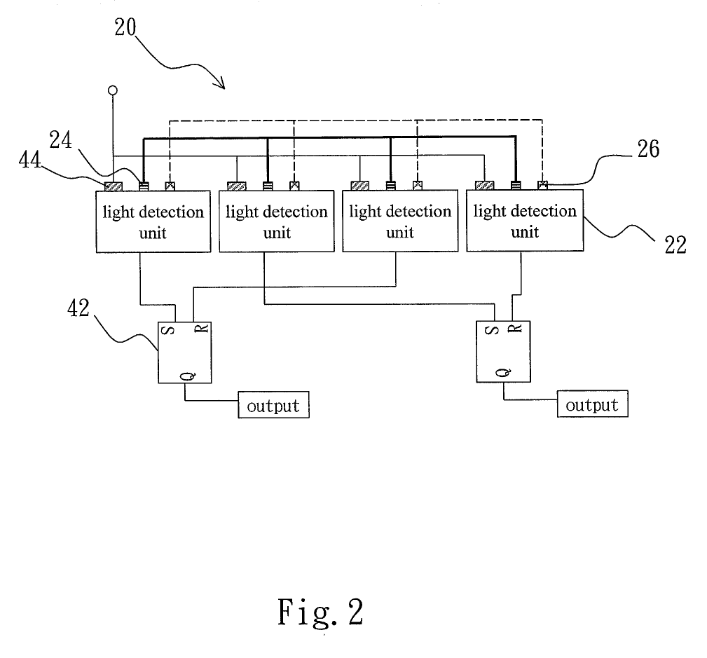

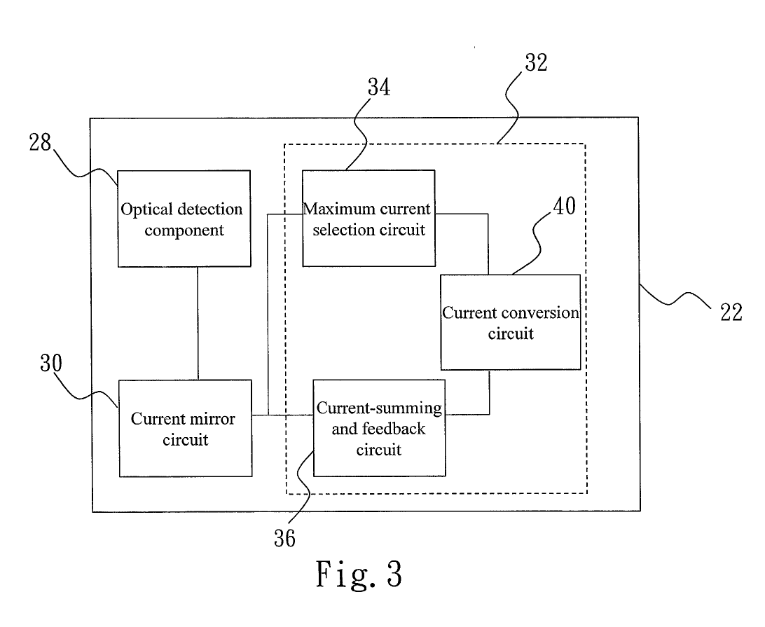

As shown in FIG. 1, a detection device 10 for detecting variations of position or angle comprises an optical mechanism, usually being a circular slotted mask 12 having a plurality of slots 14 uniformly disposed thereon. An axis 16 passes through the center of the circular slotted mask 12 so that the circular slotted mask 12 can be driven by an external mechanical device to rotate about the axis 16. A light-emitting device 18 is disposed at one side of the circular slotted mask 12. The light-emitting device 18 is used to generate a light signal for subsequent signal processing and determination of the detection device. The light source is projected to the circular slotted mask 12. An optical detector 20 is disposed at the other side of the circular slotted mask 12. The optical detector 20 is used to detect the light spot passing through the slots 14 of the rotating circular slotted mask 12, thereby detecting the variation of position of an external mechanical device for driving the circular slotted mask 12 to rotate. As shown in FIGS. 2 and 3, the optical detector 20 comprises four optical detection units 22. A first connection end 24 and a second connection end 26 are disposed on each of the optical detection units 22. The first connection ends 24 and the second connection ends 26 of the four optical detection units 22 are connected together, respectively. Each of the optical detection units 22 comprises therein an optical detection component 28, a current mirror circuit 30, and a signal selection circuit 32. The optical detection component 28 is used to convert the light passing through the slot 14 into a current signal output. The current mirror circuit 30 copies and outputs the output current signal to the signal selection circuit 32, and isolates the optical detection component 28 from the signal selection circuit 32. A maximum current selection circuit 34 is disposed in the signal selection circuit 32. The maximum current selection circuit 34 is connected to the first connection end 24 so that, through mutual connection of all the first connection ends 24, whether the optical detection unit 22 itself has the maximum current signal can be judged. A current-summing and feedback circuit 36 is also disposed in the signal selection circuit 32. The current-summing and feedback circuit 36 is connected to the second connection end 26 so that, through mutual connection of all the second connection ends 26, the current signal of the optical detection unit 22 itself can be compared with a half of a total current after all the current signals are summed up to obtain the total current. The comparison result is then outputted to a current conversion circuit 40 to generate a voltage signal output. When the current signal of the optical detection unit 22 is maximal in all the optical detection units 22, the output voltage signal is a high voltage. On the contrary, the output voltage signal is a low voltage. A power supply voltage contact 44 is also disposed on each of the optical detection units 22 to provide the required electricity for each of the above subassemblies.

The above four optical detection units 22 are grouped into two sets, each being composed of two of the light-emitting units 22 and connected to a set/reset switch 42. The voltage signal outputs of the four optical detection units 22 can thus be integrated into a pair of signal outputs. Moreover, in addition to the above circular slotted mask 12, the optical mechanism can also be replaced with another optical device capable of performing an optical processing to a light source like focusing defocusing, transmitting, or blocking.

In the present invention, the light detected by the optical detection component 28 in the optical detection unit 22 is inputted in current form, which is then outputted in voltage form after comparison by the signal selection circuit 32. When the voltage signals are outputted, the voltage signal of the optical detection unit 22 having the maximum current signal is represented by 1, while the voltage signals of the other three optical detection units 22 are represented by 0s. In other words, in the present invention, a plurality of optical detection units 22 are used to simultaneously detect the incidence of light source, and only the optical detection unit detecting the maximal current (i.e., the brightest light) has an output of 1. As compared to the prior art, the present invention can detect high-resolution variation of position. Moreover, the situation that light source passes through the transitional region between two optical detection units can be avoided. Besides, in addition to comparing the currents of four optical detection units, the output result of the maximum voltage signal of the present invention is also compared with a half of the total current. Therefore, the output voltage signal has better resistance to noise. In the present invention, when the number of the optical detection unit increases, it is only necessary to correspondingly increase the number of set/reset switch with every two of the optical detection units being connected to a set/reset switch. The design and layout of circuit is very simple.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A detection device, which is detecting variations of position or angle, said detection device comprising:
a light-emitting device used to generate a light signal for subsequent signal processing and determination; and
an optical mechanism for receiving the light signal from said light-emitting device and performing an optical processing to guide the light signal to an optical detector after said optical mechanism, said optical detector comprising a plurality of optical detection units for detecting light passing through said optical mechanism, each of said optical detection units comprising an optical detection component for converting the light source into an electric signal and a signal selection circuit connected to said optical detection component via a current mirror circuit, said optical detection unit outputting a logical electric signal and the other of said optical detection units outputting opposite logical electric signals when the current signal of said optical detection unit is maximal in all of said optical detection units.

2. The detection device as claimed in claim 1, wherein said optical processing is at least one of focusing, defocusing, transmitting, and blocking.

3. The detection device as claimed in claim 1, wherein said optical mechanism can be a slotted mask.

4. The detection device as claimed in claim 1, wherein said logical electric signal is a voltage signal.

5. The detection device as claimed in claim 1, wherein said signal selection circuit comprises:
a maximum current selection circuit having a first connection end connected to other first connection ends of the other of said optical detection units so that whether said optical detection unit has the maximum current signal in all of said optical detection units can be judged;
a current-summing and feedback circuit having a second connection end connected to other second connection ends of the other of said optical detection units so that the current signal of said optical detection unit can be compared with a half of a total current after all the current signals are summed up to obtain the total current; and
a current conversion circuit used to convert the comparison result into a voltage signal output, said optical detection unit outputting a logical electric signal and the other of said optical detection units outputting opposite logical electric signals when the current signal of said optical detection unit is maximal in all of said optical detection units.

6. The detection device as claimed in claim 5, wherein said logical electric signal is a voltage signal.

7. The detection device as claimed in claim 1, wherein every two of said optical detection units are connected to a set/reset switch.

8. The detection device as claimed in claim 1, wherein said detection device can apply to mouse devices.

9. The detection device as claimed in claim 1, wherein said detection device can apply to rotary switch devices.
